(19) United States
(12) Patent Application Publication
(10) Pub. No.: US 2014/0087032 A1
(43) Pub. Date: Mar. 27, 2014

(54) Pizza Kit and Method for Making Pizza

(71) Applicants: Thomas A. Gallo, Asheville, NC (US); Susan Devitt, Asheville, NC (US)

(72) Inventors: Thomas A. Gallo, Asheville, NC (US); Susan Devitt, Asheville, NC (US)

(73) Assignee: GALLO LEA ORGANICS LLC, Asheville, NC (US)

(21) Appl. No.: 14/094,562

(22) Filed: Dec. 2, 2013

Related U.S. Application Data
(63) Continuation-in-part of application No. 13/086,438, filed on Apr. 14, 2011, now abandoned.
(60) Provisional application No. 61/343,409, filed on Apr. 27, 2010.

(51) Int. Cl. A21D 13/00

(52) U.S. Cl. CPC A21D 13/007
USPC 426/113; 426/302

(57) ABSTRACT

There is a provided a pizza kit and a method for making a pizza from a kit. A package of powdered dough mix from the kit is opened. The powdered dough mix is poured into a bowl. The dough mix is mixed with an amount of liquid in the bowl. A dough ball is formed. The dough ball is pressed on a non-stick paper from the kit into the shape of a pizza crust. An amount of pizza sauce from the kit is added to the top of the pizza crust and the pizza is cooked.

### RELATIONSHIP TO PRIOR APPLICATION

This application is a Continuation in Part of U.S. non-provisional application Ser. No. 13/086,438 filed on Apr. 14, 2011, which further relates to and claims the benefit of U.S. Provisional Patent Application Ser. No. 61/343,409, filed Apr. 27, 2010, both of which are incorporated herein as if set forth in their entireties.

### FIELD OF THE INVENTION

This invention relates to methods and kits for making pizza.

### BACKGROUND OF THE INVENTION

When making pizza at home one can make it from scratch, starting with flour, yeast, water, etc. This tends to take 3-5 hours and is very messy but generates a good tasting and most versatile product. Frozen pizzas can be purchased which tend to contain all white bleached flour, partially hydrated oils and man-made preservatives. There are pizza kits, such as flat bread pizza kits and French bread pizza kits, that contain a preformed crust. They can be frozen, refrigerated or room temperature. These crusts are often times described as tasting dry, freezer burned, hard, chemical containing and like cardboard. These products contain many additives and preservatives. They do have the advantage in that the consumer decides on the topping. Frozen pizzas, frozen pizza crusts and frozen pizza shells, all require a great deal of energy to keep them frozen between manufacturing and consumer cooking. This increases their cost and it also increases their carbon footprint. These products use physical systems and chemical additives in an attempt to maintain freshness.

What is needed is a quick and easy to make fresh pizza that allows the consumer to control dough thickness and toppings, and which can be prepared as fast as delivered pizza or about 30 minutes.

### SUMMARY OF THE INVENTION

In accordance with one form of this invention, there is provided a pizza kit, including a first package. A second package is provided containing a dough mix. The dough mix has a water activity of 0.85 or less. A pre-cut non-stick paper is provided and is adapted to receive pressed dough in the shape of a pizza crust. The first package houses the second package and the pre-cut non-stick paper. Preferably the pizza kit contains a third package containing a sauce. The first package also contains the third package.

In accordance with another form of this invention, there is provided a method for preparing pizza from a kit. A package of powdered dough mix from the kit is opened. The powdered dough mix is poured into a bowl. The dough mix is mixed with an amount of liquid in the bowl. A dough ball is formed. The dough ball is pressed onto a non-stick paper into the shape of a pizza crust. An amount of pizza sauce is added to the top of a pizza crust and the pizza is cooked. Preferably the liquid is water or a mixture of water and milk.

### BRIEF DESCRIPTION OF THE DRAWINGS

The subject matter which is regarded as the invention is set forth in the independent claims. The invention, however, may be better understood in reference to the accompanying drawings in which:

FIG. 1 is a perspective view of a pizza kit of the subject invention.

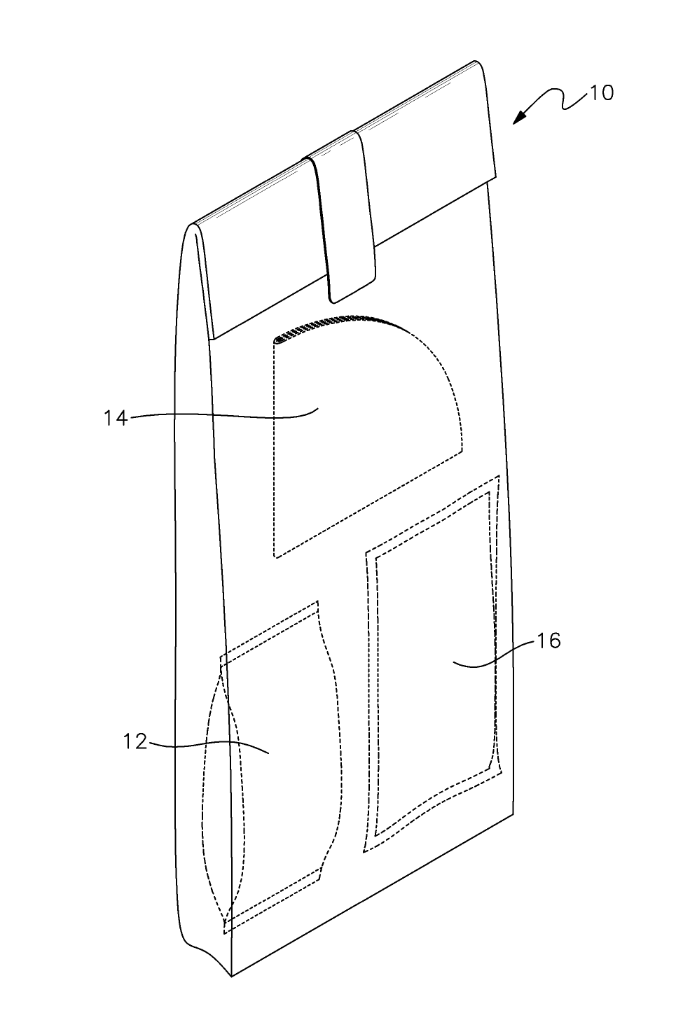

### DESCRIPTION OF THE PREFERRED EMBODIMENT

The pizza kit of the preferred embodiment of the present invention uses pre-mixed dry dough that preferably contains flour, yeast, sugar, salt, pepper and vitamin C. The ingredients are well mixed. The use of rapid rise yeast and a small amount of sugar make quick rising dough. This mix is stored at room temperature to reduce its' carbon footprint. In accordance with one form of this invention, there is provided a pizza kit, including a first package (10), which may be a paper bag or plastic bag that is sealable. A second package (12) is provided containing a dough mix. The second package holding the dough mix may also be a second bag that is sealable (i.e., a second paper bag or a second plastic bag). The dough mix has a water activity of 0.85 or less. A third package (16), again optionally in the form of a paper or plastic bag that is sealable, includes pizza sauce. In general, the pizza kit may include a first plastic bag that holds therein a second plastic bag of dough mix and a third plastic bag of pizza sauce. A pre-cut non-stick paper template (14) is provided and is adapted to receive pressed dough in the shape of a pizza crust. The non-stick paper (14) is a template or pattern for sizing and shaping a pizza crust and may be pre-cut into the shape of a circle with a diameter that ranges from 9 inches to 13 inches so that the template assists the cook in ensuring that the pizza crust is from 8 inches to 12 inches in diameter. In one embodiment, the non-stick paper (14) is a template that is pre-cut into the shape of a circle with a diameter of 12 inches. The template has a smooth, even outer edge, or perimeter, with no sharp angles or jagged edges and may be in the shape of a circle, to evenly distribute the heat of the oven and avoid burning or charring roughened edges of a baking paper that has not been cut smoothly. After all, charred edges of paper indicate a fire hazard or could at least change the taste of the pizza thereon. When the non-stick paper, or parchment paper, is torn off a larger sheet with a ragged edge, the points or jagged edges of the paper are more likely to burn or char. The same is true for sharp corners on a rectangular or square sheet of parchment paper. The template of this kit uses a round, smooth edged parchment paper that distributes the heat evenly across the pizza.

The pre-cut paper, therefore, is a template that is used as a guide for making a pizza crust that matches the same shape and the same diameter of the template, or guide, included as a non-stick paper template (14) for baking the pizza. The template or guide (14), therefore, allows a manufacturer to pre-measure and include an appropriate premeasured amount of dough mix in the dough mix bag (12) so that the consumer makes a pizza with a crust of a predetermined, or suggested, size that matches the template (14). In other words, the amount of the dough mix in the second plastic bag (12) is correlated to the size of the template (14) to make a crust that matches the diameter size and overall shape of the template (14) provided in the form of non-stick parchment paper. Accordingly, an amount of dough mix included in the second bag is pre-measured to yield a pre-measured and predetermined amount of dough appropriate for a crust having (i) a predetermined thickness and (ii) a diameter that matches the diameter of the template. The template may also include visible indicators to show a suggested diameter for thick or thin suggested crusts. The first package (whether a first paper bag or first plastic bag or otherwise) houses the second package (whether a second paper bag or second plastic bag or otherwise) and the pre-cut non-stick paper that has been folded for insertion into the bag. Preferably, the pizza kit contains a third package (whether a third paper bag or third plastic bag or otherwise) containing a sauce. The first package or bag also contains the third package or bag.

The dough is mixed with a warm liquid using a high water content to give a hydration of about 75%. This warm, wet dough easily dissolves the yeast and sugar to start fermentation. The vitamin C reduces the pH toward the optimum range for yeast growth. The vitamin C also helps the gluten develop. The pizza kit of the present invention may alternatively contain a gluten free dough. Gluten is a protein found in grains such as wheat, rye, and barley. About 1 in 133 people have Celiac disease, an autoimmune disorder of the small intestine. Celiac disease is caused by a reaction to gliadin, a prolamin (gluten protein) found in wheat, and similar proteins. Upon exposure to gliadin the enzyme tissue transglutaminase modifies the protein, and the immune system cross-reacts with the small-bowel tissue, causing an inflammatory reaction. That leads to a truncating of the villi lining the small intestine (called villous atrophy). This interferes with the absorption of nutrients, because the intestinal villi are responsible for absorption. The only known effective treatment is a lifelong gluten-free diet. While the disease is caused by a reaction to wheat proteins, it is not the same as wheat allergy. About 15% of people in the United States and 35 to 45% of people worldwide have a wheat allergy. Digestive problems, headaches and exhaustion are common negative effects of gluten. In wheat based pizza dough the gluten is also the “glue” that holds the crust together. Gluten free dough tends to be less cohesive that gluten dough and the use of parchment paper is a great help. To bind gluten free dough together it is common practice to add xanthan gum. Xanthan gum is a highly processed material and is also a laxative. The gluten free dough of the present invention uses sweet rice flour, sometimes called glutenous flour, as a binder. The binding nature of this flour comes from starch and not gluten as the common name suggests.

For a dough mix to be stable at room temperature the FDA requires a water activity of 0.85 or less. Water activity is defined as the equilibrium relative humidity (ERH) divided by 100. A water activity of 0.91 is required for salmonella species and clostridium botulinum to grow. Yeast requires a water activity of 0.88 to grow. A water activity of less than 0.65 will stop the growth of xerophilic molds sometimes found in flour. The dough mix preferably has a water activity less than 0.85 and more preferably less than 0.65. Baked products have a water activity of about 0.1 to 0.2. For flours a water activity of 0.2 to 0.6 is desirable. The dough mix may be vacuum sealed in a plastic package.

One aspect of one embodiment of the present invention is the use of parchment paper. Modern parchment paper is made by running sheets of paper pulp through a bath of sulfuric acid or sometimes zinc chloride. This process partially dissolves or gelatinizes the paper, a process which is reversed by washing the chemicals off followed by drying. This treatment forms a sulfurized cross-linked material with high density, stability and heat resistance and low surface energy—thereby imparting good non-stick or release properties.

The non-stick properties can be also achieved by employing a coated paper, for which a suitable release agent—a coating with a low surface energy and capability to withstand the temperatures involved in the baking or roasting process—is deposited onto the paper's surface; silicone (cured with a suitable catalyst) is frequently used. As used herein, non-stick paper means parchment paper or coated paper as described above.

The non-stick paper allows the consumer to make a pizza using very wet, hydrated dough without sticking or problems transferring it for topping and cooking. It also greatly reduces the effort needed to clean up after cooking. The non-stick paper improves hygiene by keeping the dough from contacting counter tops and other surfaces that might harbor germs or residual gluten.

The present invention uses a “canned” pizza sauce. As used herein, “can” may be a metal, glass or plastic package. The preferred “can” is a plastic bag made from nylon-polyethelene co-extruded film. A four gram bag was used to replace 225 grams of glass and metal. This reduces the carbon foot print of the product, reduces weight for shipping and makes the product more child friendly. An important feature of the packaging is a long shelf life and room temperature storage to reduce its' carbon footprint. The sauce itself has a pH of less than 4.6 to avoid the growth of dostridium botulinum. The term “pH” is commonly defined as the negative log of the hydrogen ion concentration.

The present invention enables one to easily make a pizza in 30 minutes from start to stomach. Also, the consumer can make a thin crust or a thick crust with the same kit. The room temperature storage of this kit makes it a low carbon footprint product.

In the description above, numerous specific details are set forth in order to provide a thorough understanding of the invention. However, it will be apparent to those skilled in the art that the invention, including structures, components and characteristics, may be practiced without these specific details.

### Example 1

A wheat based dough mix package 12 is opened and poured into a bowl containing ½ cup of warm liquid. The temperature should be above about 100° F. to help activate the yeast but not above about 135° F. which could kill the yeast. The warm liquid could be water or a mixture of water and milk, such as whole milk, low fat milk, non-fat milk, soy milk, or almond milk.

The flour and liquid is mixed with a spoon for about 75 strokes to form a dough ball. The ball is coated with about 2 teaspoons (10 mls) of oil to make it easier to handle. The dough ball is left to rest for about 5 minutes to let the gluten strands relax to aid in handling. The dough ball is then pressed out on parchment paper 14. The parchment paper is of an appropriate size and shape to use as a template for the final pizza.

The pizza sauce from package 16 is added to the pressed out dough and other toppings such as cheese might be added. The pizza and parchment paper are easily placed in an oven or on a grill using a pizza peel, cooking sheet, or the like. It is cooked directly on a grate, on a pizza stone or a metal plate/pan for about 10 minutes at 450 F to a homemade pizza in 30 minutes

### Example 2

A gluten free dough mix package is opened and poured into a bowl containing % cup of warm water. The flour and water are mixed with a spoon for about 75 strokes and pressed together using hands to form a dough ball. Parchment paper, as in Example 1, is laid out and a tablespoon, 15 mls, of oil is placed in the center. The dough ball is rolled in the oil and pressed out with hands to the size and shape of a pizza crust. This is baked for five minutes at about 450° F. and removed from the oven. Sauce and any other toppings are added and the pizza is cooked for about an additional 8 minutes to a homemade pizza in 30 minutes.

While the invention has been described in terms of the above embodiments, those skilled in the art will recognize that the invention can be practiced with modification within the spirit and scope of the appended claims.

1. A pizza kit comprising:
a first bag;
a second bag containing dough mix;
a third bag containing sauce, wherein said first, second, and third bags are plastic bags; pre-cut non-stick paper, the pre-cut non-stick paper configured as a template for pressing dough into a pizza crust that matches said template in size and shape, and
wherein the first bag contains the second and third bags and the pre-cut non-stick paper.

2. A pizza kit according to claim 1, wherein said pre-cut non-stick paper comprises a rounded outer edge along an entirety of a perimeter of said pre-cut non-stick paper.

3. A pizza kit as set forth in claim 1 wherein an amount of dough mix included in the second bag is pre-measured to yield a predetermined amount of dough appropriate for a crust having (i) a predetermined thickness and (ii) a diameter that matches the diameter of said template.

4. A pizza kit as set forth in claim 1 wherein an amount of dough mix in said second bag is correlated to a diameter of the pre-cut non-stick paper.

5. A pizza kit as set forth in claim 1 wherein the water activity of the dough mix is between 0.2 and 0.6.

6. A pizza kit as set forth in claim 1 wherein the dough mix contains flour, yeast, sugar, salt and vitamin C.

7. A pizza kit as set forth in claim 1 wherein said pizza crust matches said template in diameter.

8. A pizza kit as set forth in claim 1, wherein the sauce has a pH of less than 4.6.

9. A pizza kit as set forth in claim 1, wherein the dough mix is in powdered form.

10. A method for preparing pizza from a kit comprising:
opening a plastic bag of powdered dough mix from the kit;
pouring the powdered dough mix into a bowl;
mixing the dough mix with an amount of liquid in the bowl,
forming a dough ball;
pressing the dough ball into a shape that matches a non-stick paper template;
adding an amount of pizza sauce to the top of the pizza crust; and
cooking the pizza.

11. A method as set forth in claim 10 wherein the liquid is water.

12. A method as set forth in claim 10 wherein the liquid is a mixture of water and milk.

13. A method as set forth in claim 10 wherein the dough mix is substantially gluten free.

14. A method as set forth in claim 10 wherein the water activity of the dough mix is 0.85 or less.

15. A method as set forth in claim 14 wherein the water activity of the dough mix is less than 0.65.

16. A method as set forth in claim 15 wherein the water activity of the dough mix is between 0.2 and 0.6.

17. A method as set forth in claim 10 wherein the dough mix contains flour, yeast, sugar, salt and vitamin C.
